(19) United States
(12) Patent Application Publication
(10) Pub. No.: US 2026/0264798 A1
(43) Pub. Date: Sep. 10, 2026

(54) MOTORCYCLE HAND GRIP SYSTEM AND CUSHIONING FLANGE

(71) Applicant: Robert Morales, Huntington Beach, CA (US)

(72) Inventor: Robert Morales, Huntington Beach, CA (US)

(21) Appl. No.: 19/561,419

(22) Filed: Mar. 9, 2026

Related U.S. Application Data
(60) Provisional application No. 63/768,461, filed on Mar. 7, 2025.

(51) Int. Cl. B62K 21/26

(52) U.S. Cl. CPC B62K 21/26

(57) ABSTRACT

A motorcycle hand grip and grip system for a motorcycle handlebar has a hand grip including a cylindrical grip body with a flange at an inner end. The underside of the flange has a cushioning structure having elastomeric ribs that define hollow cavities configured to deform under hand pressure to cushion a rider's hand. In another embodiment, a grip system includes a lock-on grip on a clutch side of the handlebar and an adhesive-mounted grip on a throttle tube. The throttle-side grip may be removed and replaced without replacing the throttle tube. The system may be used with reusable throttle tubes and bearing-supported throttle assemblies.

### CROSS-REFERENCE TO RELATED APPLICATIONS

This application for a utility patent claims the benefit of U.S. Provisional Application No. 63/768,461, filed Mar. 7, 2025.

### BACKGROUND OF THE INVENTION

### Field of the Invention

The present invention relates generally to motorcycle handlebar grips. More particularly, the invention relates to motorcycle hand grips that include an integrated cushioning flange, and to grip systems that combine different attachment mechanisms on opposite sides of a motorcycle handlebar.

### Description of Related Art

Motorcycles commonly include a pair of hand grips mounted to opposite ends of a handlebar. The left side grip clutch side is typically mounted directly to the handlebar, while the right-side grip throttle side is mounted to a rotating throttle tube that is part of a throttle assembly mounted on the handlebar.

Traditional grips are mounted on the handlebar as a pair, using one of two methods. In one embodiment, the pair of grips are of a simple foam construction, and are each mounted using an adhesive. In a second embodiment, each of the pair of grips includes a rigid inner sleeve, and they are mounted via clamp-based lock-on grips.

There is a long-felt need in the industry for a pair of motorcycle grips that are “half lock,” with the left side being mounted using a clamp-based lock-on mechanism, while the right side is mounted using an adhesive. Thus far, the applicant of the present application is the first to recognize this need.

Furthermore, motorcycle grips also commonly include a flange positioned at an inner end of the grip body. The flange is semi-rigid serves to abut the rider's hand when riding. However, during aggressive riding or extended use, friction between the user's hand and the flange may cause irritation and blisters. Riders sometimes add a separate accessory known as a “grip donut,” which is typically a neoprene ring placed between the rider's hand and the flange. Such accessories may wear quickly, shift position, or become distorted.

There is therefore a long-felt need in the industry for a handgrip that does not irritate the user's hand, but which provides enhanced comfort.

### SUMMARY OF THE INVENTION

The present invention teaches certain benefits in construction and use which give rise to the objectives described below.

In one aspect, a motorcycle hand grip includes a cylindrical grip body configured to be mounted on a motorcycle handlebar or throttle tube, and a flange positioned at an inner end of the grip body. The inner-sidewall of the flange includes a cushioning structure that includes elastomeric ribs forming hollow cavities therebetween, and which are configured to elastically deform under hand pressure to create a compressible deformation zone that cushions a rider's hand and prevents friction and blistering.

In another aspect, a motorcycle grip system includes a first hand grip configured to be mounted to a left, clutch-side portion of a handlebar using a clamp-based lock-on attachment mechanism. A second hand grip is configured to be mounted to a throttle tube on the right, throttle side portion of the handlebar using an adhesive mounting interface.

In another aspect, a motorcycle control interface includes a handlebar having a left end and a right end, and a throttle assembly that includes a throttle tube mounted on the right end of the handlebar. A first hand grip is mounted on the left end of the handlebar, and a second hand grip is mounted on the throttle tube with an adhesive. The throttle tube is configured to rotate relative to the handlebar. The second hand grip is configured to be fitted over the throttle tube with an adhesive.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a motorcycle hand grip including an integrated cushioning flange.

FIG. 2 is a side elevation view that illustrates an inner-sidewall view of the flange showing elastomeric ribs and cavities.

FIG. 3 is a perspective view of a motorcycle handlebar that includes a motorcycle grip system including a left-side, lock-on clutch-side grip, and an adhesive-mounted throttle-side grip.

FIG. 4 is a side elevation view of the adhesive-mounted throttle-side grip, illustrating tie wires used to fasten the adhesive-mounted throttle-side grip to the throttle tube.

FIG. 5 is a sectional view thereof taken along line 5-5 in FIG. 4.

FIG. 6 is a cross-section view of the handgrip, illustrating a surface pattern on the handgrip for resisting rotational movement of a user's hand relative to the handgrip.

FIG. 7 is a close up of the surface pattern of FIG. 6.

### DETAILED DESCRIPTION OF THE INVENTION

The above-described drawing figures illustrate the invention, a motorcycle hand grip system for use on a motorcycle.

### Integrated Cushioning Flange

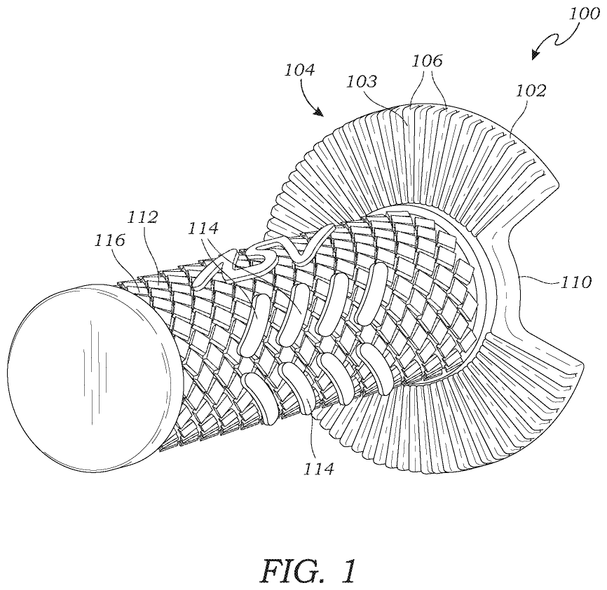

FIG. 1 is a perspective view of a motorcycle hand grip 100. In the embodiment of FIG. 1, the motorcycle hand grip 100 may include a cylindrical grip body 112 and an integrated cushioning flange 102. The cylindrical grip body 112 is configured to be mounted on a motorcycle handlebar or on a throttle tube, as discussed below.

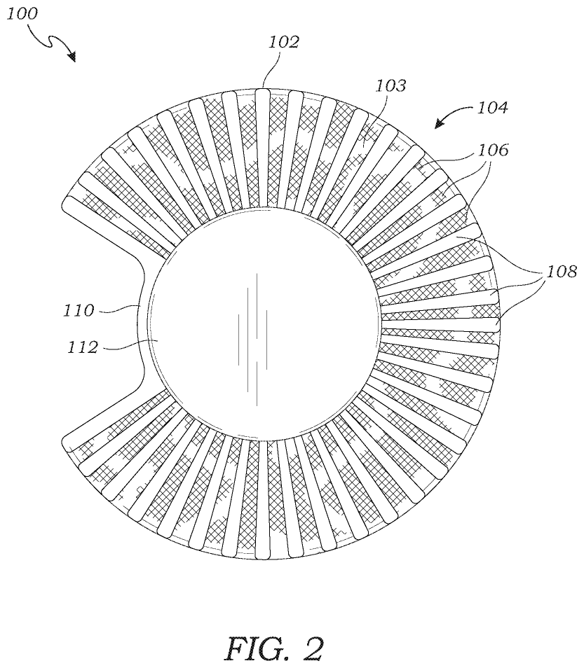

FIG. 2 is a side elevation view that illustrates an inner-sidewall 103 of the flange 102. In this embodiment, the inner-sidewall 103 of the flange 102 includes a cushioning structure 104 that includes a plurality of elastomeric ribs 108 separated by hollow cavities 106. The elastomeric ribs 106 extend from the inner-sidewall 103 of the flange 102. In this embodiment, the elastomeric ribs 108 are generally parallel, extending radially from a center of the flange 102, on an axis of the cylindrical grip body 112 to form the plurality of hollow cavities 106 between the adjacent elastomeric ribs 106. The hollow cavities 106 formed between the elastomeric ribs 108 may have various shapes and sizes depending on the desired cushioning characteristics. For example, the hollow cavities 106 may extend outwardly, radially, from the cylindrical grip body 112, or the hollow cavities 10 may form radial channels extending outwardly from the body 112, extending outwardly around the circumference of the flange 102, while in other embodiments the hollow cavities 106 may be discrete pockets positioned between adjacent elastomeric ribs 108.

The hand grip 100 may be used on either the right or left sides of a motorcycle handlebar, as discussed in greater detail below, although internal construction may vary, as discussed below, depending upon which side it is going to be used.

The flange 102 may be positioned at an inner end of the cylindrical grip body 112 i.e., the side closest to the center of the handlebar. The flange 102 may provide a barrier that prevents a rider's hand from contacting adjacent control components.

In some embodiments, the cylindrical grip body 112 may include an outer gripping surface that incorporates textured features 114 configured to improve traction between the rider's hand and the grip body 112. The textured features 114 are positioned so that they are under the user's fingertips during use, and may include ridges or projections, or other raised surface features. The body 112 may further include scale-shaped features 116, which may be triangular and include a flush end transitioning to a raised end, which extend over substantially all or a portion of the cylindrical grip body 112. In certain embodiments, the textured features 114 may be oriented in a directional configuration that provides different frictional resistance depending on the direction of hand movement relative to the cylindrical grip body 112.

When a rider's hand presses against the flange 102, the elastomeric ribs 108 may elastically deform. The deformation of the elastomeric ribs 108 may compress the hollow cavities 106 to create a compressible deformation zone beneath the flange 102. The elastomeric ribs 108 may be configured to deform in response to compressive forces applied by the rider's hand. In certain embodiments, the elastomeric ribs 108 may flex inward toward the hollow cavities 106, thereby allowing the flange 102 to move slightly relative to the cylindrical grip body 112. This controlled deformation may distribute contact pressure across a larger surface area of the rider's hand. In some embodiments, the elastomeric ribs 108 may return to an original position when the compressive force is removed.

The cushioning structure 104 may reduce friction and pressure applied to the rider's hand. The cushioning structure 104 may provide functionality similar to that provided by external grip donuts while remaining integrated with the hand grip 100. In some embodiments, the cylindrical grip body 112, flange 102, cushioning structure 104, elastomeric ribs 108, and hollow cavities 106 may be formed as a single integrally molded elastomeric component. Other constructions may also be used. The elastomeric ribs 108 may extend radially from a central region of the flange 102. Other rib orientations may also be used.

In one embodiment, the cylindrical grip body 112, flange 102, cushioning structure 104, elastomeric ribs 108, and hollow cavities 106 may be manufactured using molding processes suitable for elastomeric materials. For example, the components may be formed using injection molding, compression molding, transfer molding, or other suitable molding techniques. In some embodiments, multiple materials may be used during manufacturing, including a softer elastomeric material for the cushioning structure 104 and a relatively firmer material for portions of the cylindrical grip body 112.

The elastomeric ribs 108 may have various thicknesses and lengths depending on the desired deformation characteristics. For example, the elastomeric ribs 108 may taper from a thinner base to a thicker distal end. In other embodiments, the elastomeric ribs 108 may have uniform thickness. The number of elastomeric ribs 108 forming the cushioning structure 104 may also vary depending on design requirements.

The flange 102 may include a lever cutout 110, which provides a space for a clutch or brake lever to operate without contacting the flange. This cutout 110 also facilitates installation, as it provides guidance on how to correctly position the grip on the handlebar.

### Mixed Grip Attachment System

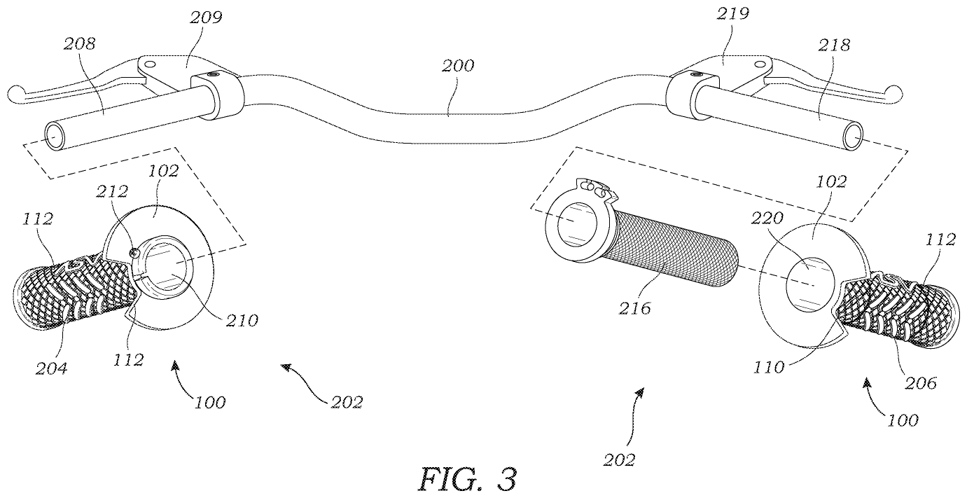

FIG. 3 is a perspective view of a motorcycle handlebar 200 that includes a motorcycle grip system 202, i.e., a pair of grips, which include a first grip, which is referred to as a left, lock-on clutch-side grip 204, and a second grip, referred to as a right, adhesive-mounted throttle-side grip 206. As shown in FIG. 3, the left, lock-on clutch-side grip 204 may be mounted to a left end 208 of the handlebar 200, which may be adjacent clutch lever 209. The left, lock-on clutch-side grip 204 includes a rigid internal sleeve 210, and a clamp-based lock-on attachment mechanism 212. The clamp-based lock-on attachment mechanism 212 is configured to securely clamp and secure the left, lock-on clutch-side grip 204 to the handlebar 200.

The right, adhesive-mounted throttle-side grip 206 may be mounted to a throttle tube 216 that is rotatably mounted on a right end 218 of the handlebar 200. The right, adhesive-mounted throttle-side grip 206 may be of soft foam construction, lacking a rigid inner sleeve (such as used on the left grip), and is attached to the handlebar 200 with an adhesive mounting interface 220 (e.g., any form of adhesive commonly used in the art). The right end 218 is typically adjacent a brake lever 219.

In some embodiments, the adhesive mounting interface 220 may include surface features configured to improve adhesion between the left hand grip 204 and the throttle tube 216. For example, the interior surface of the second hand grip 206 may include grooves, ribs, or textured surfaces configured to increase bonding area for adhesive materials. Suitable adhesive materials may include rubber-based adhesives, cyanoacrylate adhesives, polyurethane adhesives, or other bonding materials capable of securing elastomeric grips to throttle tubes.

### Tie Wire System

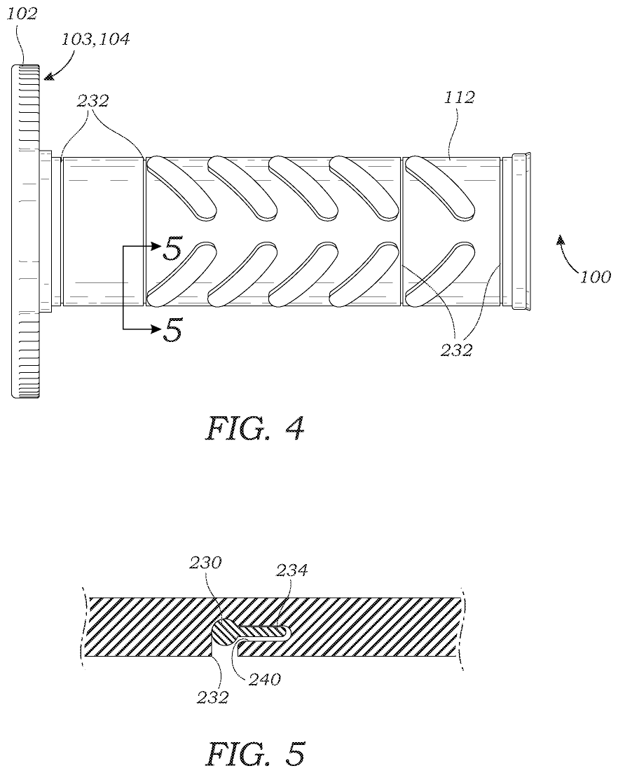

FIG. 4 is a side elevation view of the right, adhesive-mounted throttle-side grip 206 of FIG. 3. FIG. 5 is a sectional view thereof taken along line 5-5 in FIG. 4. As shown in FIGS. 4-5, the right, adhesive-mounted throttle-side grip 206 may further include one or more circumferential tie-retention grooves 232 formed in the outer surface of the cylindrical grip body 112. The grip 206 of this embodiment may be further secured to the throttle tube 216 (of FIG. 3) using one or more tie wires 230 (shown in FIG. 5). Each circumferential tie-retention groove 232 may extend around the circumference of the cylindrical grip body 112 and may define a recessed channel 240 configured to receive the retention tie wire 230. The retention tie 230 may include metal wire, a flexible metallic tie, a polymer tie, or another fastening string, thread, or band configured to be tightened around the cylindrical grip body 112 to secure the cylindrical grip body 112 relative to a handlebar or throttle tube. The circumferential tie-retention grooves 232 may position the retention tie 230 at predetermined locations along the cylindrical grip body 112, thereby preventing lateral movement of the retention tie 230 along the cylindrical grip body 112 during use.

In certain embodiments, four circumferential tie-retention grooves 232 may be spaced along the length of the cylindrical grip body 112, although alternative numbers may be used in other embodiments. For example, a first circumferential tie-retention groove 232 may be positioned near the flange 102, while additional circumferential tie-retention grooves 232 may be positioned toward an outer end of the cylindrical grip body 112. The groove floor may be recessed relative to surrounding portions of the cylindrical grip body 112 such that the retention tie 230 sits partially or completely below the surrounding outer gripping surface when installed. While four circumferential tie-retention grooves 232 are illustrated in this embodiment, other embodiments may include a different number of circumferential tie-retention grooves 232, including fewer or greater numbers of grooves depending on the desired retention configuration.

In some embodiments, the cylindrical grip body 112 may further include a tie-end recess 240 positioned adjacent each of the circumferential tie-retention grooves 232, extending under the grip surface. The tie-end recesses 240 may be configured to receive twisted tie ends 234 formed when the retention tie 230 is tightened and twisted around the cylindrical grip body 112. The tie-end recesses 240 may extend into the cylindrical grip body 112 beneath or adjacent to the circumferential tie-retention grooves 232, allowing the twisted tie ends 234 to be tucked into the tie-end recesses 240. Positioning the twisted tie ends 234 within the tie-end recesses 240 may reduce protrusions from the outer surface of the cylindrical grip body 112 and may reduce the likelihood that the twisted tie ends 234 contact the rider's hand during operation of the motorcycle.

### Surface Pattern

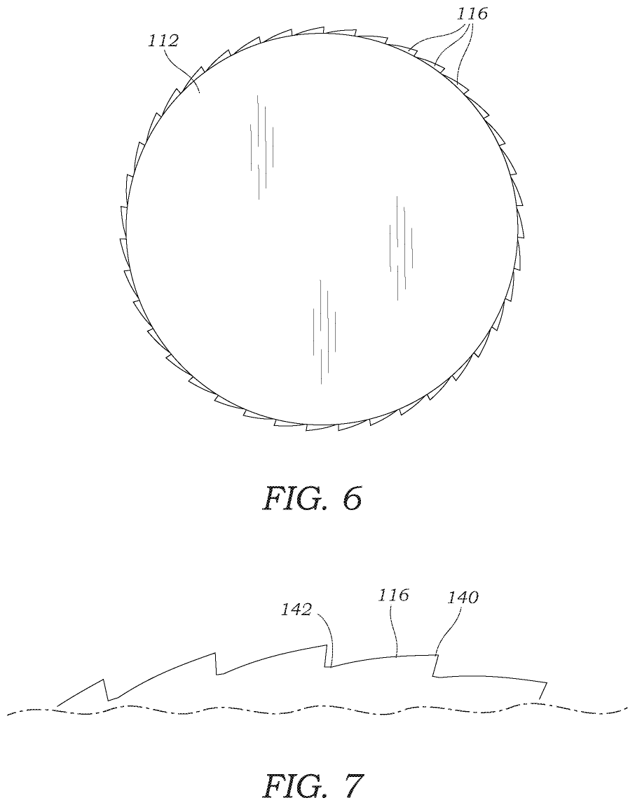

FIG. 6 is a cross-section view of the handgrip 112, illustrating a surface pattern 116 on the handgrip for resisting rotational movement of a user's hand relative to the handgrip. FIG. 7 is a close up of the surface, illustrating the structure of the surface pattern 116. As shown in FIGS. 6 and 7, the surface pattern 116 may be in the form of scale-shaped features.

In certain embodiments, the surface pattern 116 is configured to provide asymmetric resistance to rotational movement of a user's hand relative to the grip. The surface pattern may include a plurality of diamond or triangular protrusions arranged along the outer surface of the grip body. Each triangular protrusion may include a raised surface portion 140 and a recessed surface portion 142 that is recessed or relatively flush with the surrounding grip body. The raised surface portion 140 is raised above the surrounding grip surface. The diamond or triangular protrusions (or other suitable shapes) may be oriented such that the apex of each triangle is directed in a selected rotational direction relative to the longitudinal axis of the grip.

Due to this geometry, the triangular protrusions create a directional traction characteristic in which resistance to rotational movement of a user's hand in a first rotational direction differs from resistance in an opposite rotational direction. In particular, the raised apex portions of the triangular features may engage the user's hand or glove to increase resistance to rotation in one direction while permitting relatively lower resistance in the opposite direction. In this manner, the grip surface may be configured to preferentially resist rotation in a selected direction, thereby forming a unidirectional traction pattern.

In certain implementations, the triangular pattern may be oriented so that the grip provides greater resistance to rotation in a direction corresponding to forces experienced during operation of a motorcycle. For example, during acceleration, a rider's hands may experience forces tending to rotate the hands relative to the grip in a first rotational direction. The directional pattern may be configured so that the raised triangular features increase traction and resist such rotation, thereby helping maintain the rider's grip on the handlebar.

Conversely, the orientation of the triangular pattern may permit relatively easier rotational movement of the rider's hand in the opposite direction. This may allow a rider to reposition or adjust hand placement on the grip by rotating the hand relative to the grip while still maintaining contact pressure. In certain embodiments, this may assist the rider in repositioning the hands to maintain a preferred riding posture.

Such directional traction characteristics may be particularly beneficial in off-road riding environments, including motocross or dirt bike applications, where riders frequently transition between seated and standing riding positions. In these situations, maintaining proper arm and elbow positioning may require periodic adjustment of hand orientation on the grips. The unidirectional surface pattern may assist the rider in maintaining a secure hold on the grip while also facilitating controlled repositioning of the hands when needed.

### Alternative Embodiments

In another embodiment (not shown), the cushioning structure of the flange may include a different internal structure while still providing a compressible deformation zone. For example, the cushioning structure may include elastomeric lattice structures, intersecting ribs, or other compressible structures that define hollow cavities beneath the flange. In some embodiments, the cushioning structure may include partially enclosed air pockets or elastomeric cells rather than open cavities.

In another embodiment, the second hand grip may be secured to the throttle tube using mechanical engagement features such as friction surfaces, ribs, or internal gripping structures rather than adhesive mounting interface.

In another embodiment, the first hand grip may include alternative clamp-based lock-on attachment mechanisms, including single-clamp or dual-clamp configurations.

In another embodiment, the throttle tube may be constructed from materials including aluminum, steel, composite materials, or other materials capable of supporting rotation within the throttle assembly.

These alternative embodiments are intended to illustrate additional implementations and should not be interpreted as limiting the invention to any specific structure or configuration.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A motorcycle hand grip comprising:
a cylindrical grip body configured to be mounted on a motorcycle handlebar or throttle tube; and
a flange positioned at an inner end of the grip body,
wherein an inner-sidewall of the flange includes a cushioning structure comprising a plurality of elastomeric ribs extending from the inner-sidewall of the flange and defining a plurality of hollow cavities between the ribs and the flange, the ribs being configured to elastically deform under hand pressure to create a compressible deformation zone that cushions a rider's hand against the flange.

2. The motorcycle hand grip of claim 1, wherein the plurality of elastomeric ribs extend radially from a center of the flange.

3. The motorcycle hand grip of claim 1, wherein the cushioning structure is integrally molded with the grip body from an elastomeric material.

4. The motorcycle hand grip of claim 1, further comprising at least one circumferential tie-retention groove formed in an outer surface of the cylindrical grip body and configured to receive a retention tie.

5. The motorcycle hand grip of claim 4, further comprising a tie-end recess adjacent the tie-retention groove configured to receive a twisted end of the retention tie inside of the hand grip.

6. The motorcycle hand grip of claim 1, wherein the handlebar grip includes a surface pattern configured to provide asymmetric resistance to rotational movement of the user's hand relative to the handlebar grip.

7. The motorcycle hand grip of claim 6, wherein the surface pattern includes a plurality of diamond or triangular protrusions arranged along the outer surface of the grip body, and wherein each diamond or triangular protrusion may include a raised surface portion and a recessed surface portion.

8. The motorcycle hand grip of claim 7, wherein the raised surface portion is recessed or relatively flush with the surrounding grip body, and wherein the raised surface portion is raised above the surrounding grip surface, oriented such that the apex of each triangle is directed in a selected rotational direction relative to the longitudinal axis of the grip.

9. A motorcycle grip system comprising:
a first hand grip configured for attachment to a left end of a motorcycle handlebar using a clamp-based lock-on attachment mechanism; and
a second hand grip having an adhesive mounting interface configured for adhesive attachment to a motorcycle throttle tube, the throttle tube being adapted to be mounted on a right end of the motorcycle handlebar.

10. A method of mounting a motorcycle grip system, the method comprising the steps of:
providing a first hand grip configured for attachment to a left end of a motorcycle handlebar;
clamping the first hand grip on the left end of the motorcycle handlebar via a clamp-based lock-on attachment mechanism;
providing a second hand grip; and
bonding the second hand grip onto a throttle tube using an adhesive, the throttle tube being operably mounted on a right end of the motorcycle handlebar.
